(19) United States
(12) Patent Application Publication
(10) Pub. No.: US 2014/0231056 A1
(43) Pub. Date: Aug. 21, 2014

(54) HEAT EXCHANGER

(71) Applicant: CARRIER CORPORATION, Farmington, CT (US)

(72) Inventors: Jefferi J. Covington, South Glastonbury, CT (US); Abbas A. Alahyari, Manchester, CT (US); John H. Whiton, South Windsor, CT (US); Joseph B. Wysocki, Somers, CT (US); John P. Wesson, Vernon, CT (US); Daniel V. Viens, Mansfield Center, CT (US); Steven Lozyniak, South Windsor, CT (US)

(73) Assignee: Carrier Corporation, Farmington, CT (US)

(21) Appl. No.: 14/351,235

(22) PCT Filed: Sep. 25, 2012
(86) PCT No.: PCT/US2012/057075

§ 371 Date: Apr. 11, 2014

Related U.S. Application Data
(60) Provisional application No. 61/546,797, filed on Oct. 13, 2011.

(51) Int. Cl. F28F 3/12; B23P 15/26

(52) U.S. Cl. CPC F28F 3/12; B23P 15/26
USPC 165/168; 29/890.038

(57) ABSTRACT

A heat exchanger includes a plurality of tubes conveying a first fluid flow therethrough disposed substantially transverse to a direction of a second fluid flow through the heat exchanger and arranged in a plurality of tube rows extending substantially along the direction of the second fluid flow. The heat exchanger further includes a web sheet having a plurality of webs and a plurality of tube recesses disposed between the webs of the plurality of webs. Each tube of the plurality of tubes is secured to a tube recess of the plurality of tube recesses. Forming a heat exchanger includes forming a web sheet having a plurality of webs and a plurality of tube recesses located between the webs. A plurality of tubes are formed and configured to convey a first fluid flow therethrough. The plurality of tubes are inserted into the plurality of tube recesses.

### BACKGROUND OF THE INVENTION

The subject matter disclosed herein relates to heat exchangers. More specifically, the subject disclosure relates to tube and fin configuration for heat exchangers.

Micro-channel heat exchangers have represented the typical construction of heat exchangers for, for example, automotive and heating, ventilation and air conditioning (HVAC) applications, for several years. These heat exchangers are finding wider application in residential and even aerospace HVAC products due to their compactness, relatively low cost, and reduced refrigerant charge when compared to other heat exchanger configurations.

In micro-channel heat exchangers, liquid or two-phase refrigerant flows through small ports internal to extruded tubes. Air flows through folded fins arranged between the tubes. Due to the high surface density of this construction, and a flat shape of the typical tube, these heat exchangers are prone to moisture and condensate retention and subsequent frost accumulation issues. This is especially problematic when the tubes are arranged horizontally. Water collects of the horizontal surfaces of the tubes, resulting in higher flow and thermal resistance as well as corrosion and pitting of the tube surfaces.

Some heat exchangers are constructed such that the tubes are substantially integral to the fins, as shown in FIG. 1. The heat exchanger 10 has an integrated tube-fin structure where a plurality of tubes 12 are arranged with a plurality of webs 14 extending between adjacent tubes 12 of the plurality of tubes 12, and acting as fins in this structure. The configuration is typically formed as shown in FIG. 2. Two halves 16 are formed separately, each half 16 including at least a portion of the tube 12 and a portion of the web 14. The two halves 16 are secured together typically by brazing or welding. In an alterative method of forming the heat exchanger 10, the integrated tube 12 and web 14 structure is extruded as a unit. Both of these approaches require that the tube 12 and the web 14 be formed from the same material. This often results in corrosion issues resulting in leakage of refrigerant fluid from the tubes 12. Further a fluid tight seal must be maintained between the two halves 16 to prevent leakage of fluid from the tubes 12.

### BRIEF DESCRIPTION OF THE INVENTION

According to one aspect of the invention, a heat exchanger includes a plurality of tubes conveying a first fluid flow therethrough disposed substantially transverse to a direction of a second fluid flow across the heat exchanger and arranged in a plurality of tube rows extending substantially at an angle to the direction of the second fluid flow. The heat exchanger further includes a web sheet having a plurality of webs and a plurality of tube recesses disposed between the webs of the plurality of webs. Each tube of the plurality of tubes is secured to a tube recess of the plurality of tube recesses.

According to another aspect of the invention, a method of forming a heat exchanger includes forming a web sheet having a plurality of webs and a plurality of tube recesses located between the webs of the plurality of webs. A plurality of tubes are formed and configured to convey a first fluid flow therethrough. The plurality of tubes are inserted into the plurality of tube recesses and arranged substantially transverse to a second fluid flow across the heat exchanger.

According to another aspect of the invention, the formation of the plurality of webs, separate from the formation of the plurality of tubes, allows for the selection of materials such that the thickness of the material of plurality of webs can be designed to be of a different thickness than that of the material of the plurality of tubes.

These and other advantages and features will become more apparent from the following description taken in conjunction with the drawings.

### BRIEF DESCRIPTION OF THE DRAWINGS

The subject matter, which is regarded as the invention, is particularly pointed out and distinctly claimed in the claims at the conclusion of the specification. The foregoing and other features, and advantages of the invention are apparent from the following detailed description taken in conjunction with the accompanying drawings in which:

FIG. 1 is an illustration of an integrated tube and fin heat exchanger structure;

FIG. 2 is an exploded view of an integrated tube and fin heat exchanger structure;

FIG. 3 is a schematic view of an embodiment of a heat exchanger structure;

FIG. 4 is an exploded view of an embodiment of a heat exchanger structure;

FIG. 5 is an assembled view of an embodiment of a heat exchanger;

FIG. 6 is another embodiment of a heat exchanger structure;

FIG. 7 is a perspective view of an embodiment of a heat exchanger;

FIG. 8 is a cross-sectional view of an embodiment of a header for a heat exchanger;

FIG. 9 is a schematic view of a refrigerant flow pattern through a heat exchanger; and

FIG. 10 is another schematic view of another refrigerant flow pattern through a heat exchanger.

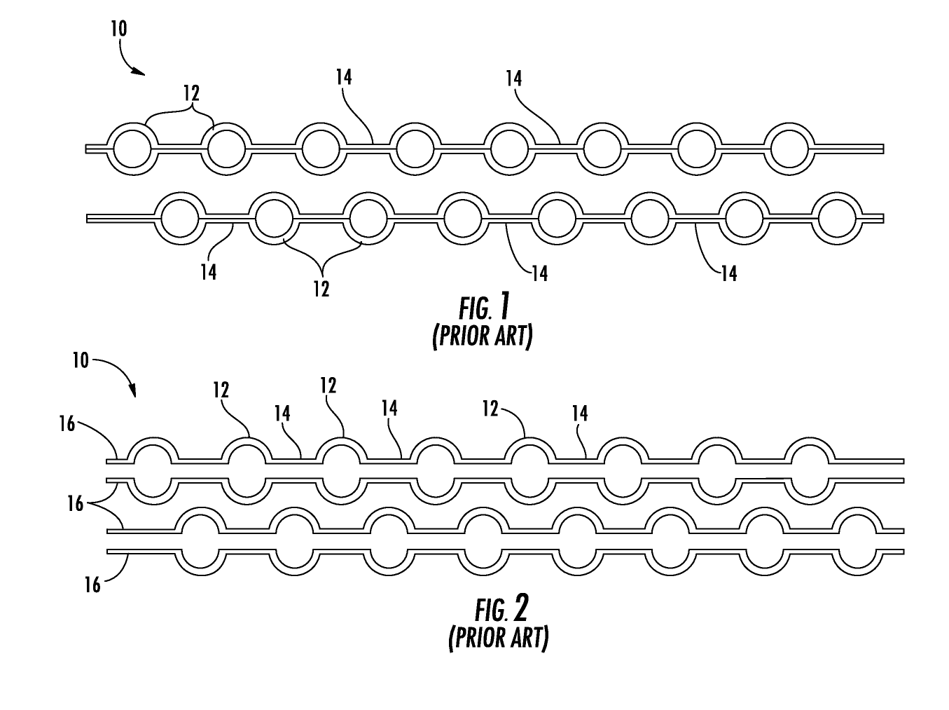

The detailed description explains embodiments of the invention, together with advantages and features, by way of example with reference to the drawings.

### DETAILED DESCRIPTION OF THE INVENTION

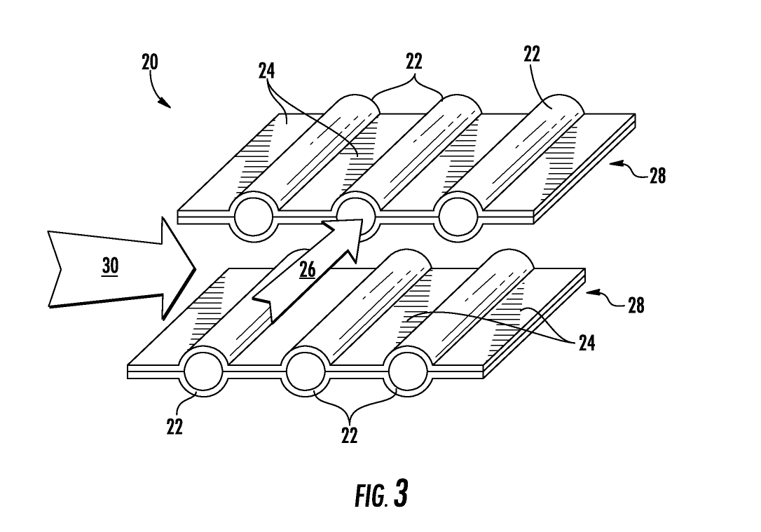

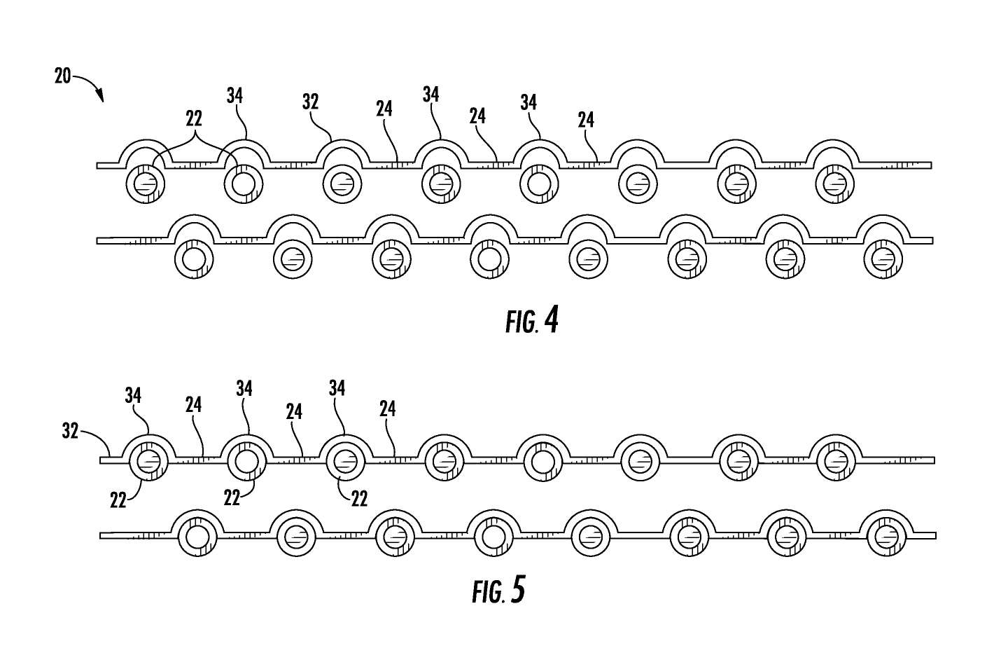

Shown in FIG. 3 is a heat exchanger 20 structure. In some embodiments, the heat exchanger 20 is a micro-channel heat exchanger (MCHX). The heat exchanger 20 includes a plurality of tubes 22 arranged with a plurality of webs 24 extending between adjacent tubes 22 of the plurality of tubes 22, and acting as fins in this heat exchanger 20. A first fluid flow 26, for example, a liquid or two phase refrigerant, is flowed through the plurality of tubes 22. While the term “first fluid flow” is utilized throughout the present application, it is to be appreciated that any selected liquid, gas or two-phase fluid may be flowed through the plurality of tubes 22 for the purposes of heat transfer. In some embodiments, the plurality of tubes 22 are arranged in rows 28. A second fluid flow 30, for example, an airflow, flows across the plurality of tubes 22 and the plurality of webs 24 such that thermal energy is transferred between the second fluid flow 30 and the first fluid flow 26 via the tube 22 and web 24 structure. In some embodiments, a direction of the airflow 30 is substantially perpendicular to the refrigerant flow 26.

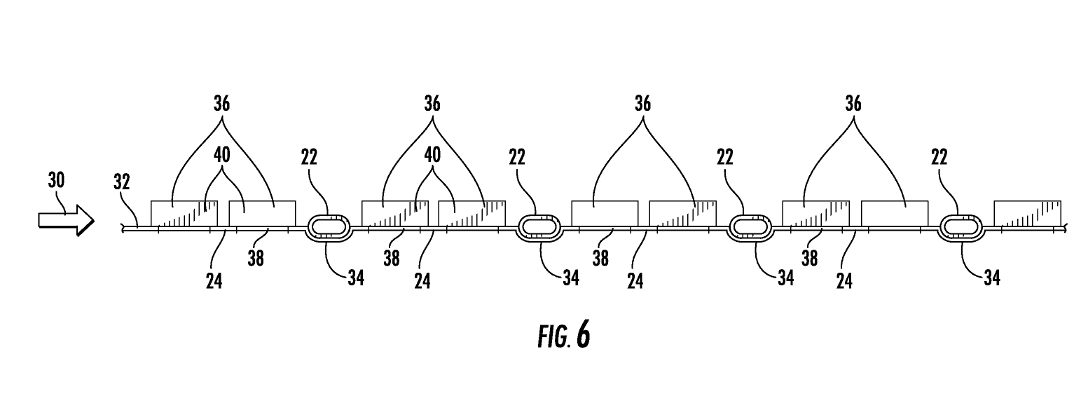

Referring now to FIG. 4, the tubes 22 of the heat exchanger 20 are formed separately from the webs 24. A web sheet 32 is formed as a single piece, by stamping, extruding, or other suitable process. The web sheet 32 includes the plurality of webs 24, with a tube recess 34 located between adjacent webs 24. The tube recess 34 is configured such that a tube 22 can be inserted in each tube recess 34, resulting in heat exchanger 20 shown in FIG. 5. The tubes 22 may be secured in the tube recesses 34 by any suitable means, for example, brazing or an adhesive.

Forming the tubes 22 separately from the webs 24 allows the tubes 22 and webs 24 to be formed from different materials to suit their specific purposes. For example, the web 24 material may be slightly anodic to the tube 22 material thereby offering a degree of corrosion protection to the tube 22 such that the choice of the materials for the web 24 and the tube 22 are selected such that the webs 24 preferentially corrode before the tubes 22 corrode. This reduces tube 22 failure and leakage. Further, the attachment of the tube 22 to the web 24 is only required for heat transfer purposes, and not for containment of fluid in the tube 22, as the tube 22 is self-contained. In other embodiments, the forming the tubes 22 separately from the webs 24 allows the tubes 22 and webs 24 to be formed from different materials to suit their manufacturability such that materials chosen for the tubes 22 can be chosen to facilitate the formation of the tubes 22 while the materials chosen for the webs 24 can be chosen to protect the tubes 22 from corrosion.

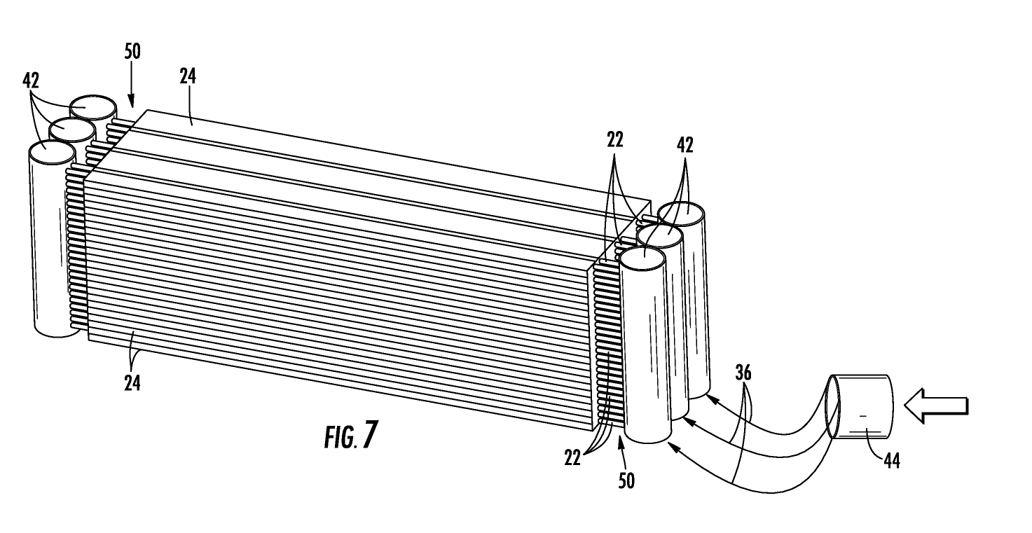

Referring now to FIG. 6, in some embodiments the webs 24 include one or more surface enhancements, for example tabs 36 extending outwardly from the web 24. In such embodiments, the tabs 36 may be formed in the web sheet 32 prior to bonding with the tubes 22, making it easier to form the tabs 36. In some embodiments, the tabs 36 are formed by punching, and result in the tab 36 extending from the web 24, and a tab hole 38 in the web itself 24 formed by the punching operation. In some embodiments, a tab face 40 is substantially aligned with a direction of the second fluid flow 30. The tabs 36 increase heat transfer between the webs 24 and the second fluid flow 30, while the tab holes 38 provide a drainage path to remove prevent buildup of moisture on the webs 24 to reduce corrosion of the webs 24.

Referring to FIG. 7, the plurality of tubes 22 may be connected to a plurality of headers 42 that distribute refrigerant flow 26 to the rows 28 of tubes 22. In the embodiment of FIG. 7, three headers 42 are shown at each end of the tubes 22, but that illustration is merely exemplary, and any quantity of headers 42 may be utilized. Ports (not shown) for introduction of the tubes 22 to the headers 42 may be formed in the headers 42 by, for example, machining or punching or the like. The tubes 22, once positioned, may be secured to the headers 42 via brazing, epoxy, swagging, or other selected process. The multiple headers 42, when compared to the single header of the typical heat exchanger, are smaller in volume and thus reduce the amount of refrigerant needed. For example, four 0.5 inch diameter headers 42 have 50% less volume than two 1 inch diameter headers. Further, the smaller headers alleviate flow distribution/circulation issues present in systems with large headers. To distribute the refrigerant flow 36 to the multiple headers 42, a distributor 44, located upstream of the headers 42, is utilized.

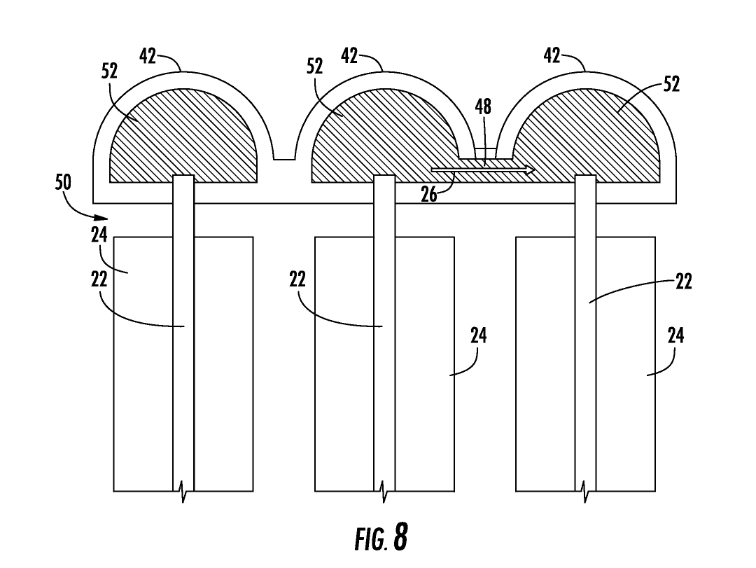

Referring now to FIG. 8, the headers 42 at a same end 50 of heat exchanger 46 may be connected by one or more through passages 48 to allow refrigerant flow 26 between the headers 42 and/or to distribute the refrigerant flow 26 to the headers 42 instead of, or in addition to, utilizing distributor 44. The headers 42 may be formed separately, or as shown in FIG. 8, may be a single header 42 with multiple header chambers 52, or a combination thereof. The multiple chambers 52 may be formed by any suitable manufacturing method, such as forming, welding, brazing, or in some embodiments may be extruded as a single unitary component.

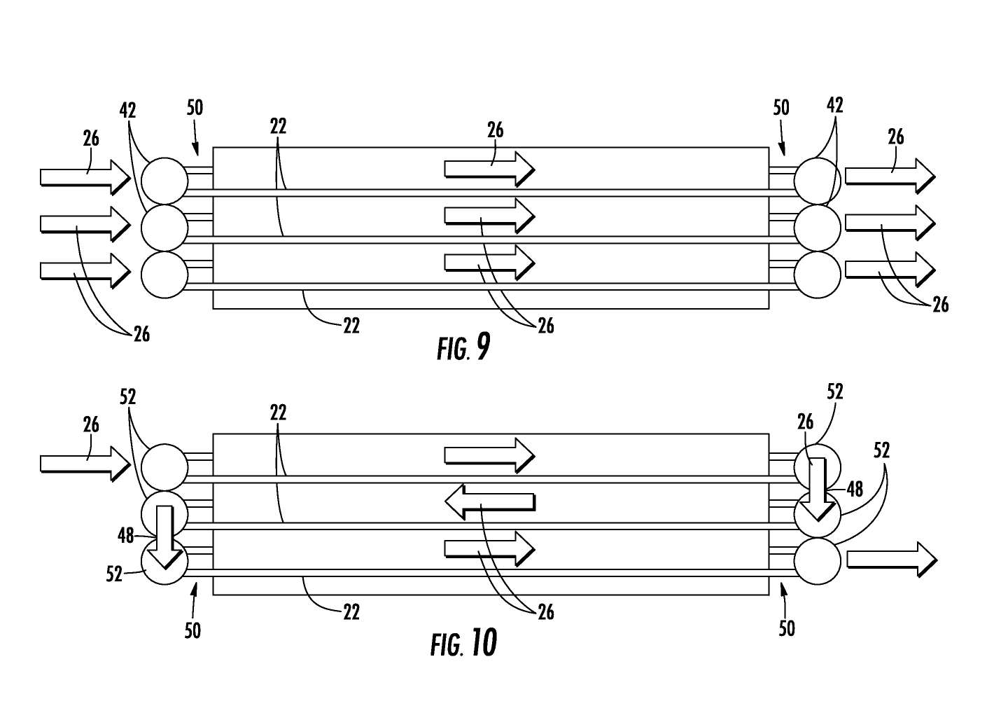

As shown in FIGS. 9 and 10, the multiple header 42 configuration at each tube end 50 and the multiple chamber 52 header 42 allow for various refrigerant flow 26 patterns through the heat exchanger 46. For example, as shown in FIG. 9, the refrigerant flow 26 may be unidirectional from a first end 50 to a second end 50. Alternatively, as shown in FIG. 10, the refrigerant flow 26 may be bi-directional, flowing in a first direction through selected tubes 22 while flowing in a second direction through other selected tubes 22, by utilizing the through passages 48 between header chambers 52.

While the invention has been described in detail in connection with only a limited number of embodiments, it should be readily understood that the invention is not limited to such disclosed embodiments. Rather, the invention can be modified to incorporate any number of variations, alterations, substitutions or equivalent arrangements not heretofore described, but which are commensurate with the spirit and scope of the invention. Additionally, while various embodiments of the invention have been described, it is to be understood that aspects of the invention may include only some of the described embodiments. Accordingly, the invention is not to be seen as limited by the foregoing description, but is only limited by the scope of the appended claims.

1. A heat exchanger comprising:
a plurality of tubes conveying a first fluid flow therethrough disposed substantially transverse to a direction of a second fluid flow across the heat exchanger and arranged in a plurality of tube rows extending substantially along the direction of the second fluid flow; and
a web sheet including:
a plurality of webs; and
a plurality of tube recesses disposed between the webs of the plurality of webs, each tube of the plurality of tubes secured to a tube recess of the plurality of tube recesses.

2. The heat exchanger of claim 1, wherein the plurality of webs include a plurality of tabs extending from the plurality of webs substantially into the second fluid flow.

3. The heat exchanger of claim 2, wherein the one or more tabs have a tab face aligned substantially parallel to the direction of the second fluid flow.

4. The heat exchanger of claim 1, wherein the plurality of tubes are formed from a first material and the web sheet is formed from a second material different from the first material.

5. The heat exchanger of claim 4, wherein the second material is anodic to the first material.

6. The heat exchanger of claim 1, further comprising a plurality of tab openings in the web sheet.

7. The heat exchanger of claim 1, wherein the plurality of tubes are secured to the web sheet via one or more of brazing or adhesive.

8. The heat exchanger of claim 1, further comprising at least one header disposed at an end of the plurality of tube rows and in fluid communication therewith.

9. The heat exchanger of claim 8, wherein the at least one header is a plurality of headers.

10. The heat exchanger of claim 9, further comprising a distributor to distribute the first fluid flow to the plurality of headers.

11. The heat exchanger of claim 8, wherein the at least one header is one header with two or more header chambers.

12. The heat exchanger of claim 11, wherein the two or more header chambers are connected by one or more through passages.

13. A method of forming a heat exchanger comprising:
forming a web sheet having:
a plurality of webs; and
a plurality of tube recesses disposed between the webs of the plurality of webs;
forming a plurality of tubes configured to convey a first fluid flow therethrough; and
inserting the plurality of tubes into the plurality of tube recesses such that the plurality of tubes are arranged transverse to a second fluid flow across the heat exchanger.

14. The method of claim 13, further comprising securing the plurality of tubes to the web sheet at the plurality of tube recesses.

15. The method of claim 14, wherein the plurality of tubes are secured to the web sheet via one or more of brazing or adhesive.

16. The method of claim 13, further comprising forming the plurality of tubes from a first material and forming the web sheet from a second material different from the first material.

17. The method of claim 16, wherein the second material is anodic to the first material.

18. The method of claim 13, further comprising forming a plurality of tabs in the plurality of webs extending from the plurality of webs substantially into the second fluid flow.

19. The method of claim 13, further comprising forming a plurality of tab openings in the web sheet.
